(19) United States
(12) Patent Application Publication
(10) Pub. No.: US 2008/0087682 A1
(43) Pub. Date: Apr. 17, 2008

(54) BOX BEVERAGE CONTAINER

(76) Inventor: Erik Overgaard, Oslo (NO)

Correspondence Address: SHERR & NOURSE, PLLC, 620 HERNDON PARKWAY, SUITE 200, HERNDON, VA, 20170, US

(21) Appl. No.: 11/688,070

(22) Filed: Mar. 19, 2007

Related U.S. Application Data
(60) Provisional application No. 60/829,266, filed on Oct. 12, 2006.

(51) Int. Cl. B67D 5/60

(52) U.S. Cl. 222/131

(57) ABSTRACT

A temperature regulating mechanism coupled to a box. The temperature regulating mechanism may include phase change material. The temperature regulating mechanism may maintain a liquid (e.g. Wine) stored in the bottle at a substantially consistent temperature (e.g. approximately 15 degrees Celsius) for a reasonable period of time.

Priority is claimed to U.S. Provisional Patent Application No. 60/829,266 (filed in the U.S. Patent and Trademark Office on Oct. 12, 2006), which is herein incorporated by reference in entirety.

### BACKGROUND

Beverages are an important part of the lives of all humans. Since the beginning of the human race, humans have been consuming beverages (e.g. water, juices, and alcohol) for sustenance and enjoyment. Over time, beverages have been crafted and developed tailored to the tastes and nutritional requirements of a given society. Along with the development of beverages, consumption habits and preferences have been cultivated specific to different beverages. For example, wine is an alcoholic beverage that is enjoyed throughout the world. The earliest evidence suggesting wine production comes from archaeological sites in Georgia and Iran, dating from 6000 to 5000 BC. Wine may be ideally served and consumed at a specific temperatures, depending on the wine. For example, medium bodied red wines are ideally served at 15 degrees Celsius, while full bodied red wines are ideally served at 18 degrees Celsius. It can be difficult in a social setting (e.g. a drinking establishment, a restaurant, homes, and picnics) to maintain wine (and other beverages) at its ideal serving temperatures for a reasonable amount of time. For example, if a family goes on a picnic in the country to enjoy wine, it may be difficult for the family to enjoy the full quality of their medium bodied red wine if they are unable to maintain the ideal temperature of 15 degrees Celsius during the duration of the picnic and travel to the country.

### SUMMARY

Embodiments relate to an apparatus including a box and a temperature regulating mechanism. The box may be configured to hold liquid (e.g. wine). The temperature regulating mechanism may be coupled to the box and may include phase change material. In embodiments, the phase change material may be specifically tailored to an ideal serving temperature of the liquid held in the box. Phase change materials is a specific class of materials that can regulate its temperature (and the temperature of liquid in contact with it).

For example a box may be used as a container for a medium bodied red wine, which is ideally served at 15 degrees Celsius or a white wine, which is ideally served at temperature ranges between 8 and 11 degrees Celsius. The box storing medium bodied red wine or white wine may include a temperature regulating mechanism with phase change material that regulates the temperature at 15 degrees Celsius (for a medium bodied red wine) or 8-11 degrees Celsius (for white wine). Accordingly, if a family goes on a picnic to enjoy premium medium bodied red wine or white wine in the countryside, they may be able to transport the premium wine in the box and serve the wine at the ideal temperature of 15 degrees Celsius (for a medium bodied red wine) or 8-11 degrees Celsius (for a white wine) hours after the family removed the box of wine from their refrigerator at home. Likewise, a box may store other alcoholic and non-alcoholic beverages and be tailored to the ideal serving temperature of that liquid (e.g. medium bodied red wines are ideally served at 15 degrees Celsius, white wines are ideally served at temperatures between 8 and 11 degrees Celsius).

### DRAWINGS

FIG. 1 illustrates an example cross-sectional view of a box and a temperature regulating mechanism coupled to the bottom of the box.

FIG. 2 illustrates an example outside view of a box and a temperature regulating mechanism coupled to the bottom of the box, with the phase change material of the temperature regulating mechanism in a substantially transparent state, indicating that the liquid contents of the box are not at an ideal serving temperature.

FIG. 3 illustrates an example outside view of a box and a temperature regulating mechanism coupled to the bottom of the box, with the phase change material of the temperature regulating mechanism in an opaque or non-transparent state, indicating that the liquid contents of the box are at an ideal serving temperature.

### DESCRIPTION

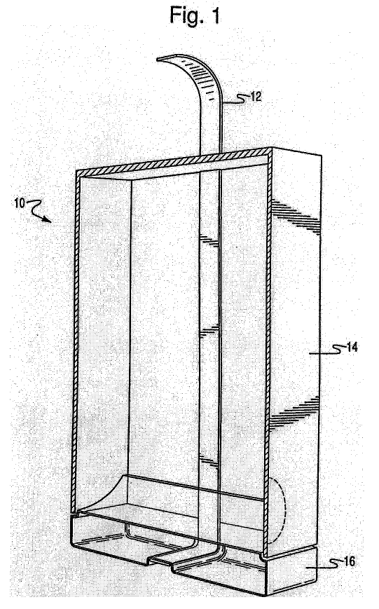

FIG. 1 illustrates an example cross-sectional view of container 10. Container 10 may include box 14, temperature regulating mechanism 16, and/or handle 12. In embodiments, temperature regulating mechanism 16 may maintain liquid inside box 14 at a predetermined temperature (e.g. below room temperature). Liquid inside box 14 may be an alcoholic beverage (e.g. wine, spirits, beer, or other alcoholic beverage) or a non-alcoholic beverage (e.g. drinking water, sports drinks, juice, coffee, tea, or other non-alcoholic beverage). Liquid inside box 14 may be liquids other than beverages (e.g. syrups, water for medical purposes, liquids use in manufacturing, liquids used for scientific experimentation, or other purposes).

Temperature regulating mechanism 16 may include phase change material. Phase change material is a class of materials that use phase changes (e.g. melting or freezing) to absorb or release relatively large amounts of latent heat at relatively constant temperatures. Phase change material is disclosed in U.S. Pat. No. 6,574,971 to Suppes, which is hereby incorporated by reference in its entirety. Phase change materials allow for a micro encapsulation and a customized melt/freeze point. When the temperature becomes warmer than the freezing point, phase change materials liquefy and absorb and store heat. Conversely, when the temperature drops, the material will solidify and give off heat, warming the material coated or impregnated with phase change material.

Phase change materials are used for a wide range of applications in the industry, and are far superior to and comparable with ordinary ice or freeze gel for many applications. For example, the U.S. army uses a cold vest filled with a phase change material to keep soldiers cool in hot conditions; the material interacts with body heath. Phase change material may be used as an insulator for Pizza delivery packaging to keep the pizza hot during transport. It may be used in air conditioning devices to accumulate cold in order to save electricity consumption.

In embodiments, a liquid can be maintained at a prescribed temperature that is specifically tailored for the ideal temperature of the liquid. Phase change material used may be non-toxic and may be made out of food grade materials such as soy. Phase change material may be used for temperature moderation of beverages (e.g. wine), and may be formulated to interact with the aroma flavor's ideal serving temperature of a particular wine (e.g. between approximately 7° C. and approximately 19° C., depending on the wine). In embodiments, phase change material is tailored to have a melting and freezing point of approximately the ideal serving temperature of the liquid inside box 14. In other words, at approximately an ideal serving temperature of the liquid inside box 14, the phase change material (which may be tailored to the liquid) will be frozen. At temperatures above approximately an ideal serving temperature of a liquid inside box 14, phase change material in temperature regulating mechanism 16 may be liquid. When phase change material is a solid and starts to melt to become a liquid, it may absorb large amounts of heat from its surroundings and thereby keep it cooler. Conversely when phase change material starts to go from a solid state to a liquid state it will release large amounts of heat and therefore aids in alcohol from getting too cold too quickly. It is the actual process of melting and freezing of phase change material that assists in temperature moderation.

In embodiments, phase change material maintains wine in box 14 at an ideal serving temperature for the particular wine. Different kinds of wines have different ideal serving temperatures. For example, many non-vintage sparkling wines have ideal serving temperatures of approximately 7° C., while many Cognacs have ideal serving temperatures of approximately 19° C. To elaborate on this example, if box 14 contains a non-vintage sparkling wine, the phase change material in temperature regulating mechanism 16 would ideally have a critical phase change temperature of 7° C. Likewise, if box 14 contains a Cognac, the phase change material in temperature regulating mechanism 16 would ideally have a critical phase change temperature of 19° C.

In embodiments, temperature regulating mechanism 16 including phase change material is coupled to box 14. In embodiments, at least a portion of temperature regulating mechanism is visible from the outside of the box. In embodiments illustrated in FIGS. 1-3, a portion of temperature regulating mechanism 16 protrudes from the bottom of box 14. However, one of ordinary skill in the art would appreciate that there are other ways to couple a temperature regulating mechanism to a box. For example, a temperature regulating mechanism including phase change material may line the inside of a box. For example a temperature regulating mechanism may be coupled to a box by being contained inside the box. In embodiments, a temperature regulating mechanism is rigidly attached to a box. In embodiments, a temperature regulating mechanism is coupled to a box by being contained in the box without being rigidly attached. In embodiment, a temperature regulating mechanism including phase change material may not be visible from the outside of a box.

As illustrated in FIG. 1, temperature regulating mechanism 16 is attached to the bottom of box 14, in accordance with embodiments. Temperature regulating mechanism 16 may protrude from the bottom of box 14, which may allow it to be visible from the outside of the box. Temperature regulating mechanism 16 may include an outer case, which may serve as a container for the phase change material. At temperatures above the freezing point of the phase change material (e.g. 15 degrees Celsius for some wines), the phase change material is a liquid. In embodiments, the case is substantially transparent (including translucent). In embodiments where the case is substantially transparent, the state of the phase change material inside the case is visible. Since the phase change material will solidify (i.e. freeze) at the tailored ideal serving temperature of the liquid in box 14, the phase (i.e. solid or liquid) may be apparent through a substantially transparent case of temperature regulating mechanism 16 through external visible inspection, in accordance of embodiments. Since the solidification of phase change material occurs at approximately the ideal serving temperature of the liquid, the solid external appearance of the phase change material of temperature regulating mechanism 16 may serve as an indicator that the liquid in the box 14 is at an ideal serving temperature, in accordance with embodiments.

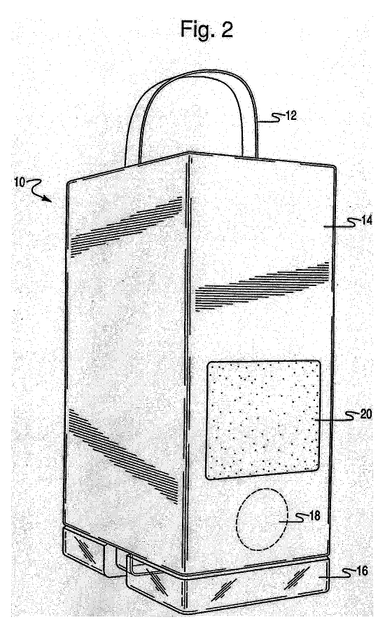

FIG. 2 is an external view of container 10, illustrating phase change material in temperature regulating mechanism 16 in a substantially transparent liquid state, in accordance with embodiments. In embodiments, when the phase change material is in a substantially transparent liquid state, it is a visual indication that the liquid to be dispensed from box 14 is above the ideal serving temperature. For example, upon a visual inspection of the transparent state of the temperature regulating mechanism 16, a consumer may be prompted to delay consumption of the contained liquid until after it has been chilled to an ideal serving temperature through refrigeration.

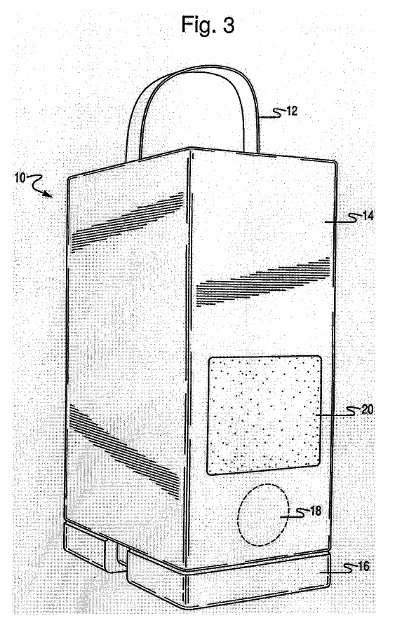

FIG. 3 is an external view of container 10, illustrating phase change material in temperature regulating mechanism 16 is a substantially non-transparent solid state, in accordance with embodiments. In embodiments, when the phase change material is in a substantially non-transparent solid state, it is a visual indication that the liquid to be dispensed from box 14 is at the ideal serving temperature. For example, upon visual inspection of the non-transparent solid state of temperature regulating mechanism 16, a consumer may feel comfortable consuming the liquid contained in box 14, because they can be confident that the liquid (e.g. wine) is at its ideal serving temperature. Further, due to the physical attributes of phase change material, the consumer may feel confident that the ideal serving temperature of the liquid will be maintained for a reasonable period of time.

In embodiments, liquid may be contained inside box 14 by being contained in a bag. The bag may contain a spigot from which the liquid is dispensed, in accordance with embodiments. As illustrated in FIGS. 2 and 3, box 14 may have opening 18 from which a spigot can emerge from box 14. Box 14 may be made of a rigid material such as paper, cardboard, plastic, polymer, wood, or other material, in accordance with embodiments. Opening 18 may be a perforated portion of box 14, in accordance with embodiments. One of ordinary skill in the art can appreciate other mechanisms for opening 18.

In embodiments, a temperature regulating mechanism may be a bag including phase change material, which also holds the liquid (e.g. wine). In embodiments, the bag may have at least two layers, with phase change material between two layers and liquid (e.g. wine) contained inside the inner layer. In embodiments, phase change material may be substantially evenly distributed between the two layers of the bag. For example, phase change material may be evenly distributed by the bag having multiple compartments isolated from each other, with each compartment containing phase change material, in accordance with embodiments. In accordance with embodiments, the multiple compartments may have a similar appear as packaging bubble wrap, with phase change material within the bubble. In accordance with embodiments, the multiple compartments may each have an elongated shape.

A two layered bag with phase change material between the layers may have the advantage of maximizing the heat transfer between the phase change material and the liquid (e.g. wine), in accordance with embodiments. As the liquid is dispensed from a box, the bag inside the box may collapse (with substantially no air entering into the bag), allowing for maximization of heat transfer between the liquid (e.g. wine) and the phase change material by maintaining the surface area contact between the phase change material in the bag and the liquid (e.g. wine), in accordance with embodiments. A temperature regulating mechanism in the form of a bag may be used by itself or in conjunction with another type of temperature regulating mechanism.

In embodiments, box 14 may contain liquid without using a bag. For example, box 14 may contain the liquid direction or box 14 may be lined with a non-permeable film. In embodiments, opening 18 may be located near the bottom of an area of box 14. As illustrated in FIG. 1, an upper surface of temperature regulating mechanism 16 may be in direct or indirect contact (in a heat transfer relationship) to the liquid in the box near the bottom of box 14 and near opening 18. In embodiments, the upper surface of temperature regulating mechanism 16 may be in the form of a groove. A groove shape of temperature regulating mechanism 16 may have a curved shape, in accordance with embodiments. Opening 18 may be aligned with the shape of the upper surface of temperature regulating mechanism 16.

Box 14 illustrated in FIGS. 1-3 is illustrated as having substantially flat surfaces, in accordance of embodiments. However, box 14 is not limited to having flat surfaces, as the surface may have curves or be rounded. Container 10 may include handle 12. A portion or portions of handle 12 may be external to box 10 and/or temperature regulating mechanism 16, in accordance with embodiments. In embodiments, handle 12 may be completely or substantially external to box 14.

The foregoing embodiments (e.g. a box and a temperature regulating mechanism) and advantages are merely examples and are not to be construed as limiting the appended claims. The above teachings can be applied to other apparatuses and methods, as would be appreciated by one of ordinary skill in the art. Many alternatives, modifications, and variations will be apparent to those skilled in the art.

1. An apparatus comprising:
a box configured to hold liquid; and
a temperature regulating mechanism coupled to the box comprising phase change material.

2. The apparatus of claim 1, wherein the liquid is a beverage.

3. The apparatus of claim 2, wherein the beverage is an alcoholic beverage.

4. The apparatus of claim 3, wherein the alcoholic beverage is wine.

5. The apparatus of claim 3, wherein the alcoholic beverage comprises at least one of:
beer; and
spirits.

6. The apparatus of claim 2, wherein the beverage is a non alcoholic beverage.

7. The apparatus of claim 6, wherein the non-alcoholic beverage comprises at least one of:
juice;
water;
carbonated soda
sports drinks;
coffee; and
tea.

8. The apparatus of claim 1, wherein the temperature regulating mechanism is visible from the outside of the box.

9. The apparatus of claim 8, wherein the phase change material is visible from the outside of the box.

10. The apparatus of claim 8, wherein the appearance of the temperature regulating mechanism shows if the liquid inside the box is at an ideal serving temperature of the liquid.

11. The apparatus of claim 10, wherein the appearance of the temperature regulating mechanism is controlled by the physical state of the phase change material.

12. The apparatus of claim 11, wherein when the liquid is at the ideal serving temperature then the phase change material appears at least one of:
opaque;
solid; and
non-transparent.

13. The apparatus of claim 11, wherein when the liquid is above the ideal serving temperature, then the phase change material appears to be substantially transparent.

14. The apparatus of claim 1, wherein the temperature regulating mechanism is coupled to the bottom of the box.

15. The apparatus of claim 14, wherein at least a portion of the temperature regulating mechanism protrudes outside of the bottom of the box.

16. The apparatus of claim 15, wherein a portion of the temperature regulating mechanism inside the box has a groove shape that interfaces with the liquid directly or indirectly in a heat transfer relationship.

17. The apparatus of claim 1, wherein the box is configured to hold a bag that contains the liquid.

18. The apparatus of claim 17, wherein:
the bag comprises an inside layer and an outside layer; and
phase change material is contained between the inside layer and the outside layer.

19. The apparatus of claim 18, wherein the phase change material is substantially evenly distributed between the inside layer and the outside layer.

20. The apparatus of claim 19, wherein:
the space between the inside layer and the outside forms isolated compartments; and
the phase change material is substantially evenly distributed between the inside layer and the outside layer by being contained in the isolated compartments.

21. The apparatus of claim 17, wherein the bag comprises a spigot which is configured to dispense the liquid.

22. The apparatus of claim 21, wherein the box comprises is configured to be opened to arrange the spigot outside the box.

23. The apparatus of claim 1, wherein the box comprises at least one of:
a handle; and
a label.

24. The apparatus of claim 1, wherein the temperature regulating mechanism is coupled to the box by being contained inside the box.

25. The apparatus of claim 24, wherein the temperature regulating mechanism is rigidly attached inside the box.

26. The apparatus of claim 24, wherein the temperature regulating mechanism is loose inside the box and is not rigidly attached inside the box.

27. The apparatus of claim 1, wherein the temperature regulating mechanism is not visible from the outside of the box.

28. The apparatus of claim 1, wherein the temperature regulating mechanism is lined along the inside of the box.
